(19) United States
(12) Patent Application Publication
(10) Pub. No.: US 2007/0075106 A1
(43) Pub. Date: Apr. 5, 2007

(54) Golf accessory

(76) Inventor: Robert Meeh, St. Louis, MO (US)

Correspondence Address: Paul M. Denk, Suite 170, 763 S. New Ballas Rd., St. Louis, MO, 63141, US

(21) Appl. No.: 11/523,229

(22) Filed: Sep. 19, 2006

Related U.S. Application Data
(60) Provisional application No. 60/722,159, filed on Sep. 30, 2005.

(51) Int. Cl. B60R 9/00; A63B 55/00; A63B 55/02

(52) U.S. Cl. 224/274; 206/315.4

(57) ABSTRACT

A golf accessory comprising a spring biased cord, within a housing, which when extended, exposes one or more clamps, for use for holding golf gloves or other golf accessories in place. A locking switch provides for fixing of the cord to the extent that it has been withdrawn from its housing, and the locking switch may be released, for allowing the cord to be drawn under the biased of spring pressure back into the housing, as during non-usage. The outer end of the cord may comprise a strip of Velcro, and may have a weighted member provided at its end, to allow for suspension of the cord from the golf bag and readily exposed for holding golf accessories, such as golf gloves, in place, during non-usage.

### CROSS REFERENCE TO RELATED APPLICATION

This nonprovisional patent application claims priority to the provisional patent application having Ser. No. 60/722,159, which was filed on Sep. 30, 2005.

### BACKGROUND OF THE INVENTION

A large number of accessory products for use in the game of golf have long been devised. For example, numerous styles of putters, irons, and drivers, of any of the various types of golf clubs that are utilized, have been devised, all primarily claiming to add to the distance that the ball can be driven, or putted, during participation in a golf match. In addition, the golf ball itself has even been modified, remanufactured, all for giving greater distance to the drive. Devices have been made to better align the club with the ball, during putting, so as to assure greater accuracy, and to decrease the golf score, through efforts to avoid missing the first putt.

In addition, various other accessories have been made, such as the golf glove, variations on the same, and many other types of devices, all to enhance and increase one's play of the game of golf.

The current invention is designed to add to the convenience of the play of golf, not so much from the standpoint of reducing the score, but simply to make it a little more easier for the golfer to obtain access to an accessory, such as a golf glove, as during participation in the sport.

### SUMMARY OF THE INVENTION

This invention principally relates to the construction of a clamping device, that may be pulled free from a housing, and furnish a series of clamps, onto which golf clubs may be secured, as during non-usage, but make the gloves readily available and accessible to the player, when needed. For example, as well known to most golfers, the use of the glove to enhance the grip has long been invoked. The problem, though, is holding onto the gloves. Frequently, after usage, the golf gloves are placed onto the cart, in the golf bag, or applied somewhere else, they become lost. This is to the dismay of the golfer, and is something the current invention is designed to alleviate, all to the pleasure of the golfer.

This invention contemplates the construction of a housing, and within the housing is a cord, chain, or other type of linkage. The cord contains a series of clamps, whether it be pressure clamps, Velcro clamps, or the like, and as the cord is pulled from the housing, a clamp becomes readily available for usage, and the golf gloves, once used, are removed, can be easily applied and held by the clamps, ready for re-usage when time and the circumstances require. The cord or cable will be spring biased into the housing, but can be pulled free under slight pressure, to the extent that the cord, and the clamps, are required for exposure, and onto which gloves may be applied. The housing may contain a switch release, which may lock the cord into position, to the extent it has been pulled free from the housing, and a locking mechanism will lock the cord into its extension, where one or more clamps may be exposed, for usage. But, the switch lock may have a release, to allow for the cord to be spring biased and retracted back into the housing, as when not in use.

The housing may include a ring, to allow for its suspension from some segment of the golf bag, preferably along its upper edge, so that the gloves will be draped from the cord, along the side of the bag, ready for usage and application, when the game requires the same.

The lower end of the cord, or that end which is at the end of the cord and is normally maintained outside the housing, may include a weighted ball, so that the cord will suspend downwardly, during usage, as can be understood.

The housing of this invention may come in different colors, so as to color coordinate it with the golf bag, since style in golfing apparently is part of the game, and something the golfers desire, so as to add to their fashion.

It is, therefore, the principal object of this invention to provide a retractable cord within a housing, but which may expose one or more clamps, to which the golf club may be applied, during its usage.

Another object of this invention is to provide a minor securing device that may be applied directly to the golf bag, in order to hold golf gloves, as when not in usage, in close proximity and readily available for usage, when required.

Still another object of this invention may provide a cord, with a series of clamps, for holding a large number of golf gloves, as when not in usage.

A further object of this invention is to provide a tape of Velcro to hold golf gloves in place when not in use.

Another object is to permanently mount a golf glove supporting housing to a golf bag.

These and other objects may become more apparent to those skilled in the art upon review of the summary of the invention as provided herein, and upon undertaking a study of the description of its preferred embodiment in view of the drawings.

### BRIEF DESCRIPTION OF THE DRAWINGS

In referring to the drawings, FIG. 1 shows a golf bag, when erect, disclosing the golf accessory comprising the golf glove holder of this invention as applied thereto;

FIG. 2 shows a side view, with a surface of the holder being removed, and disclosing its tape or cord being extended, to expose one or more clamps, or Velcro, for use for holding a plurality of golf gloves in place;

FIG. 3 shows a side view of the golf accessory of this invention, showing its tape being extended downwardly and holding one of the gloves in place;

FIG. 4 is a front view of the golf accessory;

FIG. 5 is a right side view of the golf accessory, showing its clamp lock; and

FIG. 6 is a back view, showing the spring clamp that may hold the golf accessory onto the golf club bag.

### DESCRIPTION OF THE PREFERRED EMBODIMENT

In referring to the drawings, and in particular FIG. 1, the golf bag 1 is shown supported by its base 2, upon the ground, and the golf bag, as is known, includes a length of a cylindrical member, as at 3, and has straps 4 to accommodate the carrying of the bag during usage. Normally, the upper end of the bag includes a rim, as at 5, and in this particular instance, it includes an edge, as at 6, which has the housing for the golf accessory 7 applied thereto. The golf glove accessory, as previously summarized, includes its housing 7, and from which a tape, cable, chain, cord, or the like, as at 8, suspends, and which may be pulled, to some length, and exposes a surface of Velcro fastener, or perhaps other types of clamps, as at 9, each for securement of a glove 10, as when not in usage. The end of the cable or tape may include a weight, as at 11, so as to suspend the tape downwardly, and allow the surface of Velcro or the clamps, as at 9, to be exposed, for securement thereon of a glove, or the like.

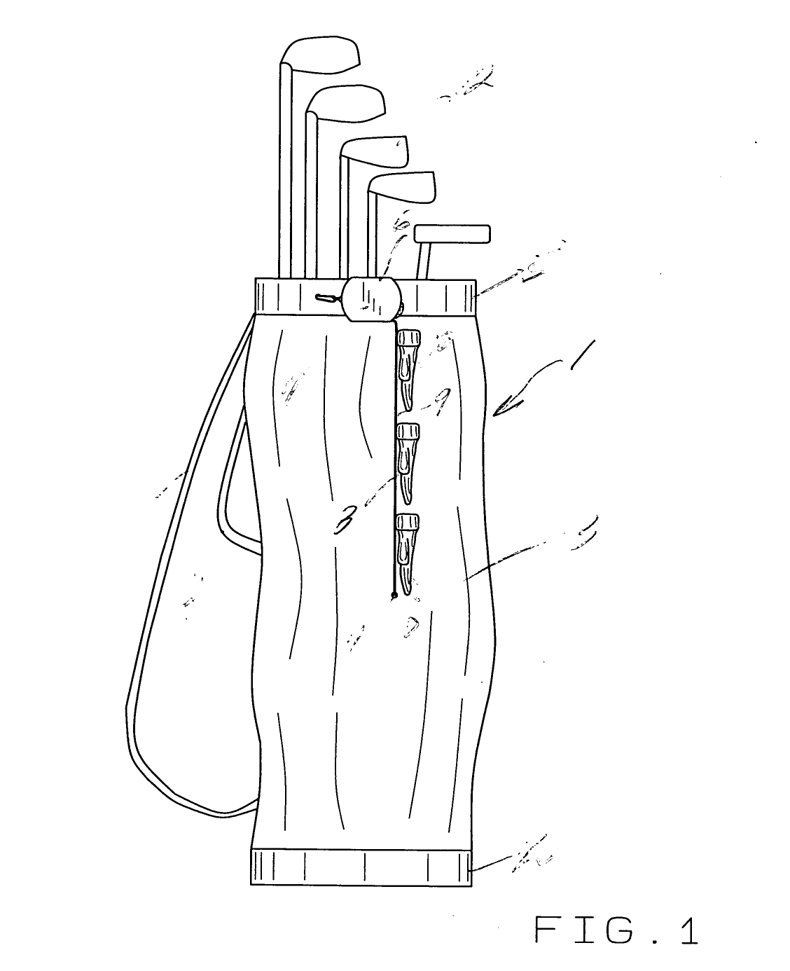

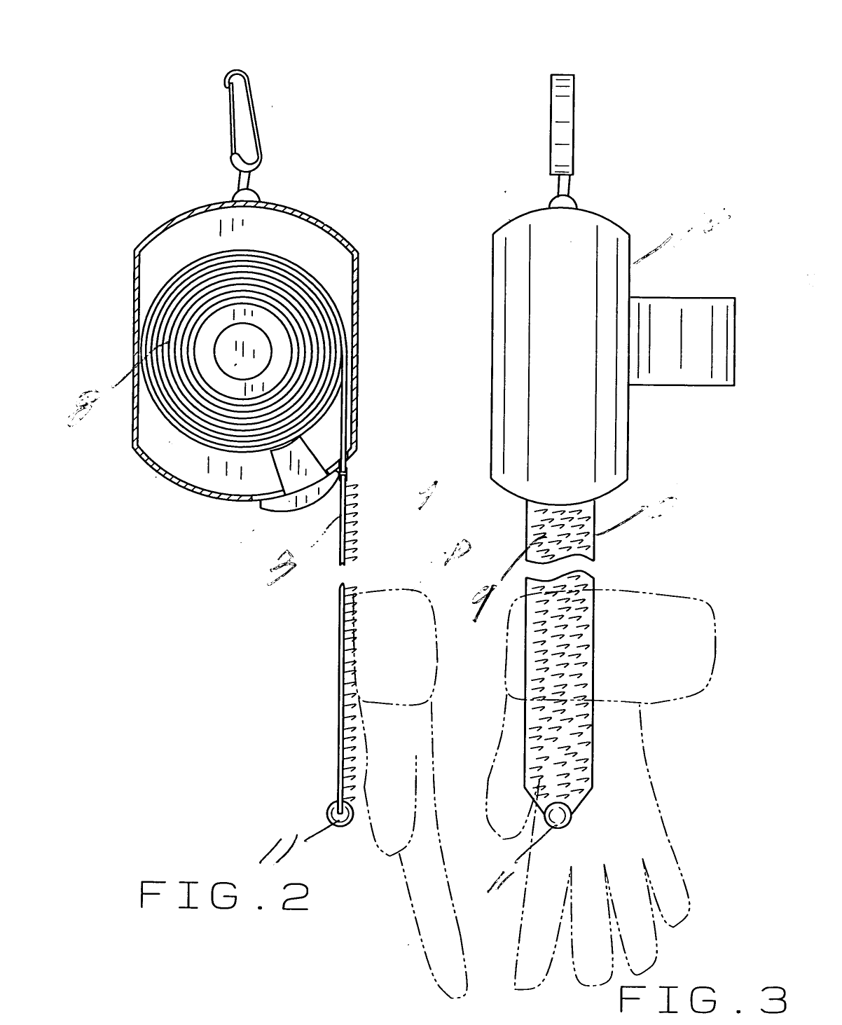

While this invention is described herein as for use preferably for holding gloves, it is just as likely that other types of accessories, that may be used in golf, may be held onto the same, such as a towel (not shown), a bag of golf tees, or other paraphernalia as used during golfing, so as to make them conveniently exposed for ready handling by the golfer, during usage and application. FIG. 2 shows the holder 7 as it is secured at the upper end of a golf bag, generally approximate to where the golf clubs, as at 12 may locate (See FIG. 1), and as can be noted, the tape, cable, or chain 8 drapes downwardly, for ready exposure and support of a plurality of items, such as one of the gloves 10, as noted, therefrom.

As can also be seen, within the housing 7, there is a spring type mount 13 that holds the tape or cable 8 wound therein, and upon pulling of the tape 8, against the resistance of its spring mount 13, it can be pulled downwardly, to expose its surface, in this instance, as shown as the Velcro 9, so that the gloves or other items may be applied thereto. A locking mechanism 14 is shown, and which can bias against the tape, within the housing, so as to lock it in position, but that when the locking mechanism is slid in an opposite direction, it releases the tape, for either rewinding, or for pulling more of the tape from the housing 7, for application of additional accessories, such as a plurality of gloves, thereto.

As can also be noted upon the side of the housing 7, there is a clip 15 that may be used for application of the accessory to the golf bag, if there is a ring or other item provided thereat, and to which the clip may be applied.

In the preferred embodiment, there is provided to the back side 16 of the housing 7 for the accessory a spring clamp, as at 18, and this type of clamp can easily be clipped to the upper edge 6 of the golf bag, as around its rim 5, to be held in position thereat, for immediate usage. As also noted in FIG. 3, it can be seen how a segment of the tape 8 has been extended downwardly, and in this particular instance exposes its Velcro surface 9 onto which the golf gloves can be applied. Obviously, as previously explained, small clips, rings, or the like, may be used in conjunction with the tape, so that the glove could be applied thereto, and held in that manner. As can also be seen, the weight 11 provides for suspension of the tape downwardly, once pulled from its housing 7.

As also noted in FIG. 2, it can be seen that the tape 8 is coil-wound, as noted, within the housing, when it is fully retracted. Usually, in this type of a spring biasing means, there is some type of a central spring within the component part 13, not too unlike that for a window shade, and which normally biases the tape 8 into rewinding, after usage. The tape or cable 8 of this invention may be of any desired length, as in the range of twelve to twenty-four inches, in order to be pulled to that extent in order to expose its fastening surface, as at 9, for holding particularly the golf gloves in place. As is known, golf gloves have a Velcro surface, for holding the glove to the golfer's hand, and that same Velcro can be used for application to the surface 9, to hold the gloves firmly in place, during non-usage.

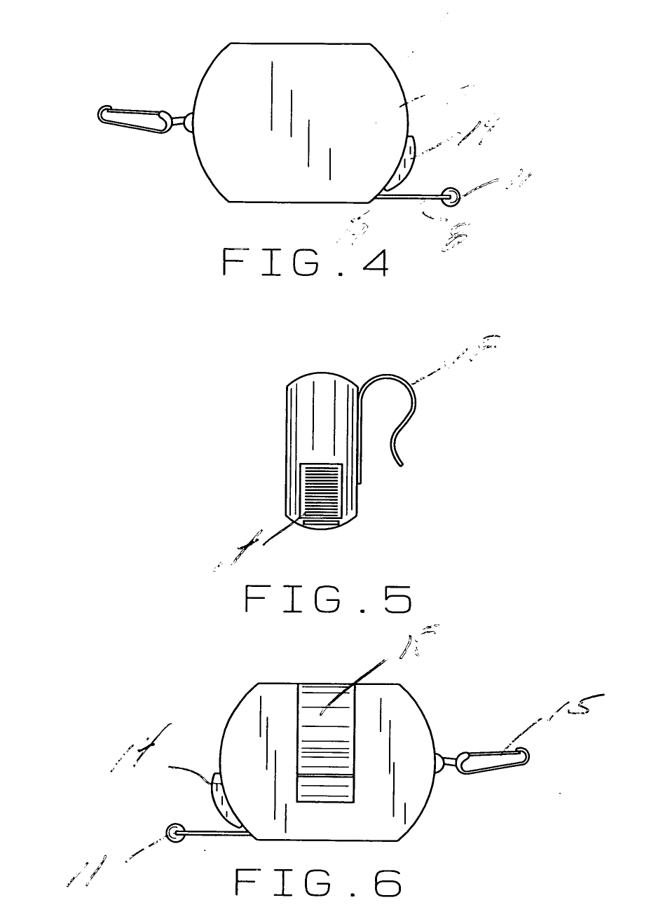

FIG. 4-6 disclose the golf accessory 7 for its various components as previously described, such as having a series of surfaces, as at 8, in this instance, the surface 8 being the front of the accessory when applied. And, it has its fastener 15 extending from one side, the locking mechanism 14 arranged approximate the access opening, as at 19, along one edge of the housing, and the tape 8 with its weight 11 as can be noted. In addition, FIG. 5 shows the spring clip 18 and how it may be biased attached to the upper edge of the golf bag, to hold the accessory in place. Its locking mechanism 14 likewise can be readily seen.

As can be readily understood, the locking switch 14 cooperates with the cable 8, such that when it is withdrawn from the housing, the locking switch will lock the tape into its extended or withdrawn position, so as to expose a length of the Velcro surface, or other types of fasteners, as many as may be needed to hold as many of the gloves, or other paraphernalia, to be clamped in place. But, when the switch 14 is depressed or slid, it functions as a release, to allow the spring biasing of the tape holder to withdraw the tape back into the housing, or to allow it to be rewound, as when not in usage.

As previously explained, FIG. 3 readily discloses how a strip of Velcro may be used with the tape or cable 8, with this strip of Velcro being secured therewith, and it will extend downwardly with the weighted, at its end, as at 11, so that the gloves may be applied directly to the Velcro surface, and be held in position thereat, as during non-usage. For example, most golf gloves have a Velcro feature provided as a fastener at their end, as in the vicinity of the palm or the backside of the golfer's hand, and which can be tightened in place, to secure the golf glove upon the hand, ready for driving or hitting of a ball with an iron, or driver, during participation in said sport. A type of strip or Velcro can be extended downwardly from the shown accessory, as noted in FIG. 3, or a cord or other type of means for holding other fasteners may be provided, down to its weighted end, for holding golf gloves or other accessories in place. Depending upon the length of the Velcro strip 9, will determine the number of golf gloves that can be held and secured thereto during usage and application of this invention.

It is also likely that the golf accessory of this invention may be built into the golf bag, rather than just secured by a ring with a snap hook or spring fastener, and such construction may be integrated or riveted to the golf bag rim 5, when the bag is initially manufactured. This would make the accessory as a part of the golf bag itself, in preparation for usage. Furthermore, the housing for the device may be made to a variety of colors, so as to match the color of the golf bag, or to any color to which the golfer prefers, for style purposes.

Variations or modifications of the subject matter of this invention may occur to those skilled in the art upon reviewing the subject matter of this disclosure. Such variations or modifications, if within the spirit of this development, are intended to be encompassed within the scope of the invention as described herein. The description of the preferred embodiment, and the depiction of the invention in the drawings, are set forth for illustrative purposes only.

1. A golf accessory for connecting to a golf bag, comprising a housing, the housing having a biasing spring rotatably mounted and provided centrally therein, a cord connecting with said spring, within the housing, and the cord capable of being withdrawn from the housing to expose a fastener, to which golf gloves may be secured or adhered, as during non-usage, and the cord may be withdrawn under the bias of the spring back into the housing, during non-usage.

2. The golf accessory of claim 1 wherein said cord comprises a tape, the tape having a surface of Velcro applied thereto, and for use for facilitating the holding of golf gloves to said tape during usage.

3. The golf accessory of claim 2 and including a locking switch, mounted to the golf accessory housing, and which is useful for holding the tape in its extended position, but upon its release, allowing the tape to be withdrawn back into the housing under the influence of the spring.

4. The golf accessory of claim 1 and including a fastener, secured to the golf accessory housing, and capable of fastening to the golf bag, during usage.

5. The golf accessory of claim 1 and including a spring clamp, secured to the surface of the housing of the golf accessory, and said spring clamp capable of clamping onto a golf bag, to hold a golf accessory in position during usage.

6. The golf accessory of claim 4 wherein said tape may be pulled a substantial distance to allow for the application of a plurality of golf gloves thereto, during their temporary storage as during non-usage.

7. The golf accessory of claim 1 wherein said cord includes a series of clamps, each clamp capable of holding a golf glove or other accessory in position, during non-usage.

8. The golf accessory of claim 1 wherein said cord includes a weight at its distal end, to facilitate the suspension of the cord downwardly, when extracted from the housing, for securement of one or more golf gloves to the cord during their non-usage.

9. The golf accessory of claim 1 wherein said golf accessory through its housing is permanently affixed to a golf bag.
